(19) United States
(12) Patent Application Publication
(10) Pub. No.: US 2015/0089241 A1
(43) Pub. Date: Mar. 26, 2015

(54) Image Sensor and Payment Authentication Method

(71) Applicant: GALAXYCORE SHANGHAI LIMITED CORPORATION, Shanghai (CN)

(72) Inventor: Lixin Zhao, Shanghai (CN)

(21) Appl. No.: 14/367,291

(22) PCT Filed: Dec. 18, 2012
(86) PCT No.: PCT/CN2012/086865

§ 371 Date: Dec. 8, 2014

(30) Foreign Application Priority Data
Dec. 22, 2011 (CN) 201110435920.2

(51) Int. Cl. H04L 29/06; G06Q 20/40

(52) U.S. Cl. CPC H04L 63/0861; G06Q 20/40145
USPC 713/186

(57) ABSTRACT

The invention relates to an image sensor and a payment authentication method. The image sensor includes: a sensing module configured to optically sense an image and to convert an optical signal of the image into an image signal; and an encryption module configured to encrypt the image signal and to output the encrypted image signal. The payment authentication method includes the steps of: converting an individual image into an image signal by an image sensor, wherein the image sensor includes a sensing module configured to optically sense an image and to convert an optical signal of the image into an image signal and an encryption module configured to encrypt the image signal; encrypting the image signal by the image sensor; and transmitting the image signal processed in the preceding step. With the image sensor and the payment authentication method of the invention, the security of mobile and remote payment may be greatly improved.

### CROSS-REFERENCE TO RELATED APPLICATIONS

This application claims priority to the Chinese Application for Patent No. 201110435920.2, entitled “Image Sensor and Payment Authentication Method,” filed on Dec. 22, 2011, the entire disclosure of which is hereby expressly incorporated by reference herein.

### FIELD OF THE INVENTION

The present disclosure relates to an image sensor and particularly to an image sensor and a payment authentication method.

### BACKGROUND OF THE INVENTION

Mobile and remote payment has increasingly become a necessity for people to pay for their shopping along with rapid development of smart phones and mobile internet, but how to perform secured, rapid and convenient payment authentication has remained as an issue to be addressed. At present, a payment authentication scheme commonly used in mobile and remote payment is by using a password. However, this payment authentication scheme is susceptible to interception or embezzlement of the password, thus hindering the security of payment and consequently bringing an adverse influence and even a significant loss to a user.

In view of this, it is desirable to provide a highly secured payment authentication method or an authentication device.

### SUMMARY OF THE INVENTION

In order to address the foregoing problem, the invention provides an image sensor. This image sensor may optically sense a physical human-face feature or a fingerprint and convert the physical human-face feature or the finger into an image signal, which is then encrypted in the image sensor into an encrypted image signal and further transmitted to the outside of the image sensor. This encrypted image signal has high security and may effectively prevent the image signal from being intercepted or embezzled for illegal use by another person. With the image sensor of the invention used in a mobile and remote payment process, as the image signal transmitted through a communication system to a server for authentication or for manual authentication is an encrypted image signal, the security of the mobile and remote payment process may be greatly improved.

According to a first aspect of the invention, there is provided with an image sensor, wherein the image sensor includes: a sensing module configured to optically sense an image and to convert an optical signal of the view into an image signal; and an encryption module configured to encrypt the image signal and to output the encrypted image signal.

With the inventive image sensor, the image signal may be encrypted inside the image sensor, and then the encrypted image signal may be transmitted to the outside. The encrypted image signal has high security and may prevent effectively the image signal from being intercepted or embezzled.

Preferably, the inventive image sensor further includes: an image signal processing module configured to process the image signal so that the processed image signal is provided with an image sensor identifier corresponding to the image sensor, and to provide the processed image signal to the encryption module. Using the image sensor identifier is equivalent to giving a corresponding “identification” to the image signal to clearly identify from which image sensor the image signal originates to thereby facilitate subsequent processing of the image signal.

Further preferably, the image signal processing module processing the image signal further includes: processing the image signal with a first encryption algorithm corresponding to the image sensor identifier. With the image sensor identifier used, the image signal may be encrypted with the encryption algorithm corresponding to the image sensor identifier to thereby further improve the security of the encrypted image signal.

Preferably, the encryption module in the inventive image sensor is further configured to receive an encryption enabling signal and to determine whether to encrypt the image signal based on the encryption enabling signal.

The encryption enabling signal may be used to improve the flexibility of the signal processing, and the user may choose as desired whether to encrypt the obtained image signal.

Further preferably, the encryption module is further configured to receive a public key when the encryption enabling signal is valid and to encrypt the image signal with a default encryption scheme if the encryption module fails to receive the public key; or to encrypt the image signal using the public key if the encryption module receives the public key.

The encryption module will encrypt the image signal regardless of whether the public key is received to thereby ensure the signal to be encrypted and improve the security of the signal.

Still further preferably, the image sensor further includes an authentication module configured to judge authenticity of a server that transmits the public key to the encryption module.

The authentication module may effectively prevent the image signal from being encrypted using a fake public key transmitted from an illegal server to thereby avoid the image signal from being leaked.

Preferably, the sensing module and the encryption module in the inventive image sensor are packaged in a same chip.

This can be done for the advantages of a small volume, a low cost, high robustness to interference and suitability for massive production of the integrated circuit.

According to a second aspect of the invention, there is provides with a payment authentication method including the steps of: b. converting an individual image into an image signal by an image sensor, wherein the image sensor includes a sensing module configured to optically sense an image and to convert an optical signal of the image into an image signal and an encryption module configured to encrypt the image signal; d. encrypting the image signal by the image sensor; and e. transmitting the image signal processed in the step d.

Since the image sensor used in the inventive payment authentication method encrypts the image signal before transmitting it, even if the encrypted image signal is intercepted, the image signal may not be decrypted and thus will not be leaked, which provides high security, and with this image sensor, the security of mobile and remote payment authentication may be greatly improved.

Preferably, the inventive payment authentication method further includes: c. processing the image signal so that the processed image signal is provided with an image sensor identifier corresponding to the image sensor. The sensor identifier is equivalent to an “identification” of the image signal to clearly identify from which image sensor the image signal originates to thereby facilitate subsequent processing of the image signal.

Further preferably, the step c further includes: encrypting the image signal with a first encryption algorithm corresponding to the image sensor identifier. The first encryption algorithm corresponds to the image sensor identifier.

Preferably, before the step d, the inventive payment authentication method further includes: receiving an encryption enabling signal and determining whether to encrypt the image signal based on the encryption enabling signal. The encryption enabling signal may improve the flexibility of the signal processing, and the user may choose as desired whether to encrypt the obtained image signal

Further preferably, a public key is received when the encryption enabling signal is valid and the image signal is encrypted with a default encryption scheme if the encryption module fails to receive the public key; or the image signal is encrypted using the public key if the encryption module receives the public key. The encryption module will encrypt the image signal regardless of whether the public key is received to thereby ensure the signal to be encrypted and improve the security of the signal. In case that the public key is used for encryption, the image signal needs to be decrypted using a private key corresponding to the public key, and the corresponding private key is held by a legal receiver of the encrypted image signal, which may greatly reduce the possibility of leaking the image signal.

Preferably, the individual image in the inventive payment authentication method includes a human face or a fingerprint. The human face or the fingerprint is the most representative individual feature image and may correspond uniquely to an individual identification and consequently will greatly facilitate identification authentication.

According to a third aspect of the invention, there is provides with a payment authentication method including the steps of: f. receiving an encrypted image signal, wherein the image signal is generated by an image sensor including a sensing module configured to optically sense an image and to convert an optical signal of the image into an image signal and an encryption module configured to encrypt the image signal into the encrypted image signal; h. decrypting the encrypted image signal; i. comparing the decrypted image signal with an original image signal corresponding to the individual image to obtain an authentication result; and j. determining whether a mobile payment succeeds based on the authentication result.

Since the image signal received in the inventive payment authentication method is an encrypted image signal, even if the encrypted image signal is intercepted, the image signal may not be decrypted and thus will not be leaked, which will provide high security

Preferably, the step f in the inventive payment authentication method further includes: processing the image signal by the image sensor so that the processed image signal is provided with an image sensor identifier corresponding to the image sensor. Correspondingly thereto, before the step h, the inventive payment authentication method further includes the step of: g. obtaining the image sensor identifier, judging authenticity of the image sensor identifier and determining from the judgment result whether to decrypt the encrypted image signal.

When a user transmits the image signal with the image sensor identifier, a server receives the signal and then searches in a user name-image sensor identifier correspondence table pre-stored on the server for an image sensor identifier corresponding to the user name, and if the found image sensor identifier is consistent with the received image sensor identifier, then the image sensor identifier is judged to be authentic, that is, it is determined that a payment behavior is initiated by a payer, and thus the encrypted image signal is decrypted. In this way, the security of payment may be further improved.

Or further preferably, the processing in the step f further includes performing a first encryption on the image signal with a first encryption algorithm corresponding to the image sensor identifier. Correspondingly thereto, before the step h, the inventive payment authentication method further includes: g. obtaining the image sensor identifier, judging authenticity of the image sensor identifier and performing a first decryption on the image signaling with a first decryption algorithm corresponding to the obtained image sensor identifier when the image sensor identifier is authentic.

Preferably before the step f, the inventive payment authentication method further includes: transmitting a public key to the image sensor so that the image sensor encrypts the image signal based upon the public key. Correspondingly thereto, the step g further includes: performing a second decryption on the image signal base upon a private key corresponding to the public key.

A private key corresponding to the public key used by the image sensor for encryption is held by the legal server, and the image signal encrypted by the public key may not be decrypted by any other illegal private key, thereby greatly improving the security of payment.

Preferably, the individual image in the inventive payment authentication method includes a human face or a fingerprint. The human face or the fingerprint is the most representative individual feature image and may correspond uniquely to an individual identification and consequently will greatly facilitate identification authentication.

### BRIEF DESCRIPTION OF DRAWINGS

The foregoing and other features of the invention will become more apparent from the following detailed description of embodiments illustrated in connection with the drawings, and like reference numerals denote like or similar components throughout the drawings in which:

FIG. 1 is a schematic diagram of an image sensor according to a first embodiment of the invention;

FIG. 2 is a schematic diagram of an image sensor according to a second embodiment of the invention;

FIG. 3 is a schematic diagram of an image sensor according to a third embodiment of the invention;

FIG. 4 is a schematic diagram of an image sensor according to a fourth embodiment of the invention;

FIG. 5 is a flow chart of an identification authentication method according to a fifth embodiment of the invention;

FIG. 6 is a flow chart of an identification authentication method according to a sixth embodiment of the invention;

FIG. 7 is a flow chart of an identification authentication method according to a seventh embodiment of the invention; and

FIG. 8 is a flow chart of an identification authentication method according to an eighth embodiment of the invention.

### DETAILED DESCRIPTION OF EMBODIMENTS

The invention will be described below in details with reference to the drawings.

FIG. 1 is a schematic diagram of an image sensor according to a first embodiment of the invention.

As illustrated in FIG. 1, in this embodiment, the image sensor of the invention is implemented as an image sensor 100 in which a sensing module 110 and an encryption module 120 are packaged together. The sensing module 110 is configured to optically sense an external image and to convert an optical signal of the image into an image signal, which may be an analogy signal or a digital signal as a result of analogy to digital conversion, and then transfer the image signal to the encryption module 120. The encryption module 120 is configured to encrypt the image signal with a default encryption algorithm, which may be a specific fixed encryption algorithm preset in the encryption module or a specific encryption algorithm selected from several encryption algorithms in a hardware or software manner, and finally the encrypted image signal is output. Dependent upon different application in practice, the sensing module 110 and the encryption module 120 may be fabricated on different dies and then packaged together; or may be integrated in the same die and then packaged.

With the image sensor 100, the image signal may be encrypted inside the image sensor, and then the encrypted image signal may be transmitted to the outside of the chip. The encrypted image signal has high security, which may effectively prevent the image signal from being embezzled to thereby improve the security of the image signal.

Preferably, the encryption module 120 may be further configured to receive an encryption enabling signal and to determine whether to encrypt the image signal based on the encryption enabling signal. When the encryption enabling signal is valid, the encryption module 120 encrypts the image signal with the default encryption algorithm to get the encrypted image signal; and when the encryption enabling signal is not valid, the encryption module 120 directly outputs the image signal generated by the sensing module 110 without encrypting the image signal. The encryption enabling signal may be used to enable the user to choose as desired whether to encrypt the obtained image signal.

Further preferably, when the encryption enabling signal is valid, the encryption module 120 is further configured to receive a public key and to encrypt the image signal in a default encryption scheme if the encryption module 120 fails to receive the public key; and to encrypt the image signal using the public key if the encryption module 120 receives the public key. Here, the default encryption scheme refers to that the encryption module 120 encrypts the image signal with the above default encryption algorithm.

The image sensor of the invention may encrypt the image signal inside the image sensor and then transmit the encrypted image signal to the outside, and the encrypted image signal provided with high security may effectively prevent the image signal from being leaked. Preferably, the image sensor is implemented in the form of an integrated circuit chip and thus has the advantages of a small volume, a low cost, high robustness to interference and suitability for massive production.

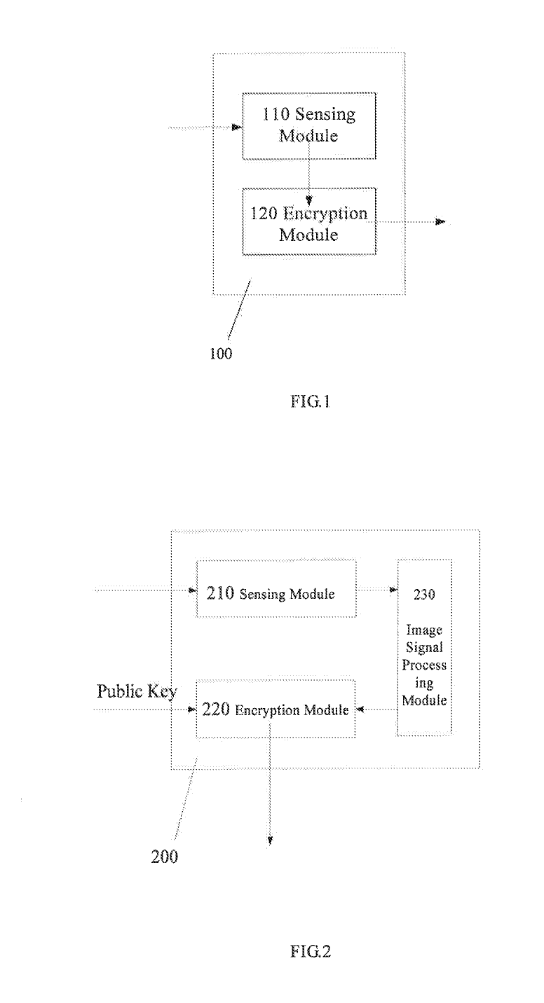

FIG. 2 is a schematic diagram of an image sensor according to a second embodiment of the invention.

As illustrated in FIG. 2, in this embodiment, the image sensor of the invention is implemented as an image sensor 200 in which a sensing module 210, an encryption module 120 and an image signal processing module 230 are packaged in a chip. The chip refers to an integrated circuit block with packages, typically provided with circuit pins for connection with external devices.

The sensing module 210 is configured to optically sense an external image and to convert an optical signal of the image into an image signal, which may be an analogy signal or a digital signal, and then transfer the image signal to the image signal processing module 230.

The image signal processing module 230 is configured to process the image signal so that the processed image signal is provided with an image sensor identifier corresponding to the image sensor. The image sensor identifier may be a string of identification characters preset in the image sensor upon shipment from a factory, corresponding uniquely to the image sensor. The image sensor identifier is equivalent to an “identity label” attached to the image signal to clearly identify from which image sensor the image signal originates, and the “identity label” may be recognized by a receiving device to determine whether a payment behavior is initiated by a payer.

Preferably, the image signal processing module 230 processing the image signal further includes encrypting the image signal with a first encryption algorithm corresponding to the image sensor identifier. With the image sensor identifier used, the image signal may be encrypted in the encryption algorithm corresponding to the image sensor identifier. When the image sensor transmits the processed image signal to a server, for example, the server may determine the corresponding first encryption algorithm according to the image sensor identifier and further determine a decryption algorithm corresponding to the first encryption algorithm to decrypt the image signal. As can be appreciated, in a practical application, different sensor identifiers may correspond respectively to different first encryption algorithms, that is, different first encryption algorithms may be used by different image sensors for encryption. Alternatively, different sensor identifiers may correspond to the same first encryption algorithm. For example, a first type of the first encryption algorithm may be used by some of the image sensors for encryption, and a second type of the first encryption algorithm different from the first type may be used for the other image sensors for encryption.

Finally, the processed image signal with the image sensor identifier or the image signal with the image sensor identifier encrypted with the first encryption algorithm is provided to the encryption module, where the encryption algorithm may be a default encryption algorithm such as at least a specific fixed encryption algorithm preset in the encryption module or at least a specific encryption algorithm selected in a hardware or software manner from several encryption algorithms.

Preferably, the encryption module 220 may be further configured to receive an encryption enabling signal and to determine whether to encrypt the image signal based on the encryption enabling signal. When the encryption enabling signal is valid, the encryption module 220 encrypts the image signal with the default encryption algorithm into the encrypted image signal; and when the encryption enabling signal is not valid, the encryption module 220 directly outputs the image signal generated by the sensing module 210 without encrypting the image signal. The encryption enabling signal may be used to enable the user to choose as desired whether to encrypt the obtained image signal.

Further preferably, when the encryption enabling signal is valid, the encryption module 220 is further configured to receive a public key and to encrypt the image signal in a default encryption scheme if the encryption module 220 fails to receive the public key; and to encrypt the image signal using the public key if the encryption module 220 receives the public key. Here the default encryption scheme refers to that the encryption module 220 encrypts the image signal with the above default encryption algorithm.

The image signal processing module 230 introduces the image sensor identifier and/or the first encryption, and the image sensor identifier may identify data source of the image signal to thereby further improve the security of the transmitted encrypted image signal.

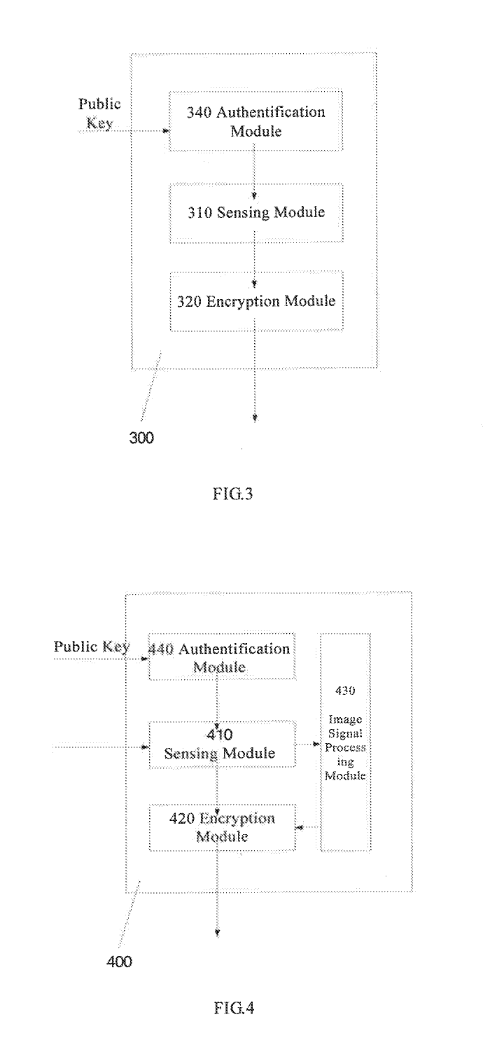

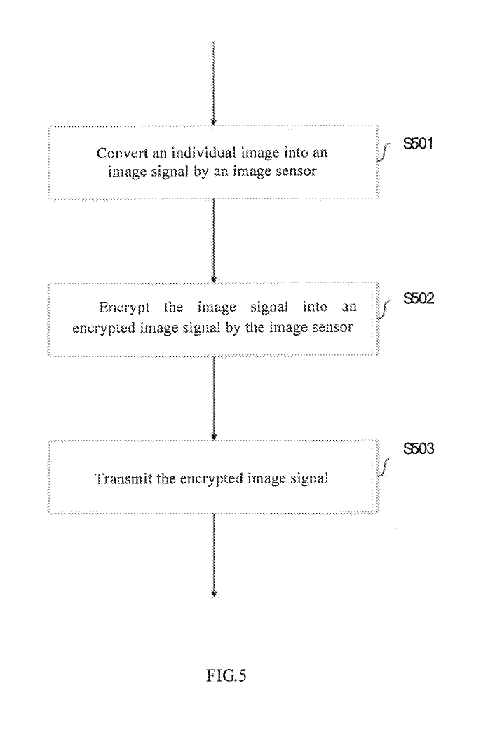

FIG. 3 is a schematic diagram of an image sensor according to a third embodiment of the invention.

As illustrated in FIG. 3, in this embodiment, the image sensor of the invention is implemented as an image sensor 300 in which a sensing module 310, an encryption module 320 and an authentication module 340 are packaged together.

The authentication module 340 is configured to judge authenticity of a server that transmits a public key to the encryption module. Only if the server that transmits the public key is judged to be authentic, the sensing module 310 will optically sense an external image and convert an optical signal of the image into an analogy or digital image signal and then transfer the image signal to the encryption module 320 for encryption by the encryption module 320 to obtain an encrypted image signal for output. The sensing module 310 will not acquire any external image signal when the server that transmits the public key is judged to be unauthentic.

The authentication module 340 may effectively prevent the image signal from being encrypted using a fake public key transmitted from an illegal server to thereby avoid the image signal from being leaked.

FIG. 4 is a schematic diagram of an image sensor according to a fourth embodiment of the invention.

As illustrated in FIG. 4, in this embodiment, the image sensor of the invention is implemented as an image sensor 400 in which a sensing module 410, an encryption module 420, an image signal processing module 430 and an authentication module 440 are packaged together.

The authentication module 440 is configured to judge authenticity of a server that transmits a public key to the encryption module. Only if the server that transmits the public key is judged to be authentic, the sensing module 410 will optically sense an external image and convert an optical signal of the image into an analogy or digital image signal and then transfer the image signal to the image signal processing module 430. The sensing module 410 will not acquire any external image signal when the server that transmits the public key is judged to be unauthentic. The image signal processing module 430 is configured to process the image signal so that the processed image signal is provided with an image sensor identifier corresponding to the image sensor. The image sensor identifier may be a string of identification characters preset in the image sensor upon shipment from a factory, corresponding uniquely to the image sensor, and the image sensor identifier is equivalent to an “identity label” attached to the image signal to clearly identify from which image sensor the image signal originates.

Preferably, the image signal processing module 430 processing the image signal further includes encrypting the image signal with a first encryption algorithm corresponding to the image sensor identifier. With the image sensor identifier used, the image signal may be encrypted with the first encryption algorithm corresponding to the image sensor identifier.

Finally, the processed image signal with the image sensor identifier or the image signal with the image sensor identifier encrypted with the first encryption algorithm is provided to the encryption module 420 for encryption, where the encryption algorithm may be a default encryption algorithm such as at least a specific fixed encryption algorithm preset in the encryption module or at least a specific encryption algorithm selected in a hardware or software manner from several encryption algorithms. For each time of encryption, at least one of the above encryption schemes may be predetermined or randomly selected in a hardware or software manner in the encryption module 420 as desired in practice.

The authentication module 440 may effectively prevent the image signal from being encrypted using a fake public key transmitted from an illegal server to thereby avoid the image signal from being leaked. The image signal processing module 430 introduces the image sensor identifier and/or the first encryption to thereby further improve the security of the transmitted encrypted image signal.

Preferably, the encryption module 420 may be further configured to receive an encryption enabling signal and to determine whether to encrypt the image signal based on the encryption enabling signal. When the encryption enabling signal is valid, the encryption module 420 encrypts the image signal with an encryption algorithm into the encrypted image signal; and when the encryption enabling signal is not valid, the encryption module 420 directly outputs the image signal generated by the sensing module 410 without encrypting the image signal.

The encryption enabling signal may be used to improve the flexibility of processing the signal, and the user may choose as desired whether to encrypt the obtained image signal.

Further preferably, when the encryption enabling signal is valid, the encryption module 420 is further configured to receive a public key and to encrypt the image signal with a default encryption scheme if the encryption module 420 fails to receive the public key; and to encrypt the image signal using the public key if the encryption module 420 receives the public key. Here the default encryption scheme refers to that the encryption module 420 encrypts the image signal with the above default encryption algorithm.

Particularly, the authentication module may judge authenticity of the server that transmits the public key in the following steps: the image sensor transmits an authentication code to the server, and the server obtains a calculation result of the server by using the authentication code based on a predetermined algorithm and returns the calculation result of the server to the image sensor. In the meantime, the image sensor also obtains a calculation result of the image sensor by using the authentication code based on the same predetermined algorithm and judges whether the calculation result of the image sensor is consistent with the calculation result of the server. If they are consistent, then the server that transmits the public key is judged to be authentic; otherwise, the server that transmits the public key is judged to be unauthentic. The judging method is not limited thereto, but including other methods such as pre-storing identification information of legal servers in the image sensor and judging the server that transmits the public key to be authentic if the received identification information of the server is consistent with the pre-stored identification information of legal servers, and judging it to be unauthentic otherwise.

The encryption module will encrypt the image signal regardless of whether the public key is received to thereby ensure the signal to be encrypted and improve the security of the signal. The authentication module may effectively prevent the image signal from being encrypted by using a fake public key transmitted from an illegal server to thereby avoid the image signal from being leaked.

FIG. 5 is a flow chart of an identification authentication method according to a fifth embodiment of the invention, where the image sensor may be the image sensor used in the foregoing embodiments which includes a sensing module configured to optically sense an image and to convert an optical signal of the image into an image signal and an encryption module configured to encrypt the image signal.

As illustrated in FIG. 5, firstly in the step S501, the image sensor converts an individual image into an image signal.

Then in the step S502, the image sensor encrypts the image signal into an encrypted image signal. Preferably, the image sensor is configured to receive an encryption enabling signal and to be controlled by the encryption enabling signal to determine whether to encrypt the image signal based on the encryption enabling signal. Further preferably, the image sensor receives a public key when the encryption enabling signal is valid and encrypts the image signal in a default encryption scheme if the public key fails to be received; or encrypts the image signal using the public key if the public key is received. The default encryption scheme may be a scheme to use at least a specific fixed encryption algorithm preset in the image sensor or to select at least a specific encryption algorithm in a software or hardware manner from several encryption algorithms.

Then in the step S503, the image sensor transmits the encrypted image signal. The image sensor transmits the encrypted signal to a receiver such as a server through a communication system.

Since the image sensor used in the payment authentication method of this embodiment encrypts the image signal before transmitting the image signal, even if the encrypted image signal is intercepted, the image signal may not be decrypted and thus will not be leaked and consequently will have good security. With this image sensor, the security of mobile and remote payment authentication may be greatly improved.

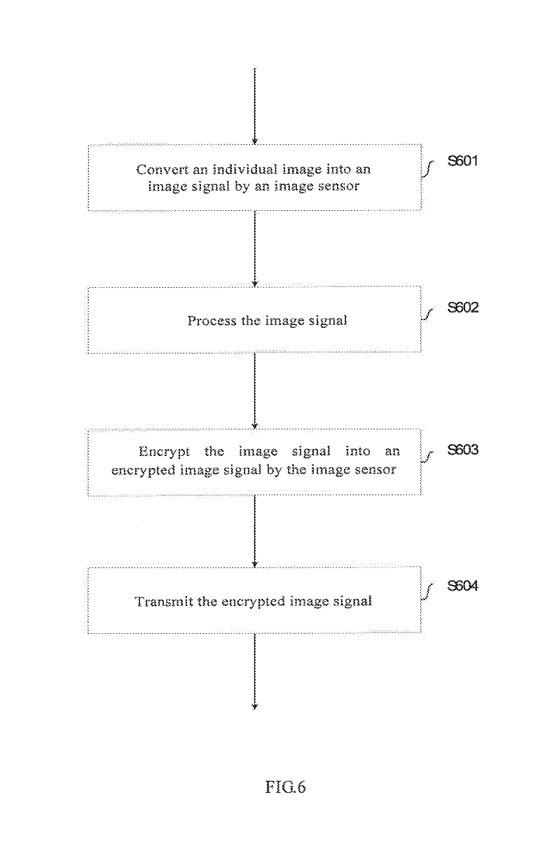

FIG. 6 is a flow chart of an identification authentication method according to a sixth embodiment of the invention.

As illustrated in FIG. 6, firstly in the step S601, an image sensor converts an individual image into an image signal.

Then in the step S602, the image sensor processes the image signal, where the processing includes processing the image signal so that the processed image signal is provided with an image sensor identifier corresponding to the image sensor. Preferably, the processing further includes encrypting the image signal with a first encryption algorithm corresponding to the image sensor identifier.

Then in the step S603, the image sensor encrypts the image signal into an encrypted image signal. Preferably, the image sensor is configured to receive an encryption enabling signal and to be controlled by the encryption enabling signal to determine whether to encrypt the image signal based on the encryption enabling signal. Further preferably, the image sensor receives a public key when the encryption enabling signal is valid and encrypts the image signal with a default encryption scheme if the public key fails to be received; or encrypts the image signal using the public key if the public key is received. The default encryption scheme may be a scheme such as using at least a specific fixed encryption algorithm preset in the image sensor or to select at least a specific encryption algorithm in a software or hardware manner from several encryption algorithms.

Finally in the step S604, the image sensor transmits the encrypted image signal. The image sensor transmits the encrypted image signal to a receiver through a communication system.

The sensor identifier used in the payment authentication method of this embodiment is equivalent to an “identification” of the image signal to clearly identify from which image sensor the image signal originates to thereby facilitate subsequent processing of the image signal; in addition to the image sensor identifier, the first encryption is further introduced to thereby further improve the security of the transmitted encrypted image signal; the use of an encryption enabling signal may improve the flexibility of processing the signal, and the user may choose as desired whether to encrypt the obtained image signal; and the encryption module will encrypt the image signal regardless of whether the public key is received to thereby ensure the signal to be encrypted and improve the security of the signal. Authentication of the server may effectively prevent the image signal from being encrypted using a fake public key transmitted from an illegal server to thereby avoid the image signal from being leaked.

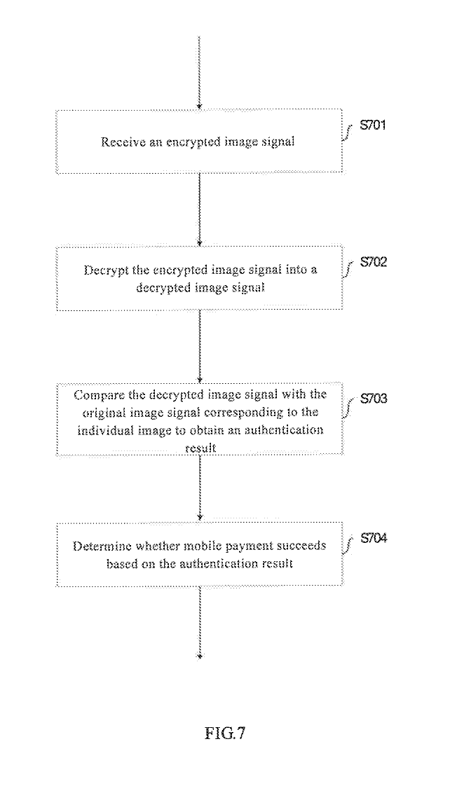

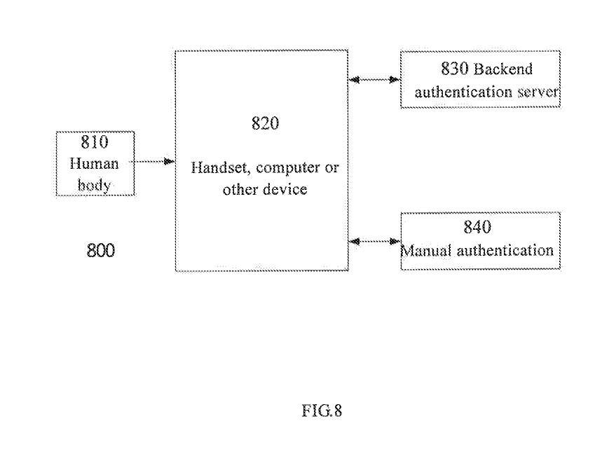

FIG. 7 is a flow chart of an identification authentication method according to a seventh embodiment of the invention.

As illustrated in FIG. 7, firstly in the step S701, a receiver receives an encrypted image signal, where the image signal is obtained by an image sensor including a sensing module configured to optically sense an image and to convert an optical signal of the image into an image signal and an encryption module configured to encrypt the image signal into the encrypted image signal. Particularly, the receiver may be a backend authentication server or a manual authentication server.

Then in the step S702, the receiver decrypts the encrypted image signal into a decrypted image signal.

Next in the step S703, the receiver compares the decrypted image signal with an original image signal corresponding to the individual image to obtain an authentication result.

Finally in the step S704, the receiver determines whether mobile payment succeeds based on the authentication result.

Preferably, the step S701 further includes: processing the image signal by the image sensor so that the processed image signal is provided with an image sensor identifier corresponding to the image sensor. Correspondingly thereto, there is further included before the step S702 the steps of obtaining the image sensor identifier, judging authenticity of the image sensor identifier and determining from a judgment result whether to decrypt the encrypted image signal. This judgment may be made as follows: when a user transmits the image signal with the image sensor identifier, a server receives the signal and then searches in a user name-image sensor identifier correspondence table pre-stored on the server for an image sensor identifier corresponding to the user name, and if the found image sensor identifier is consistent with the received image sensor identifier, then the image sensor identifier is judged to be authentic, that is, it is determined that a payment behavior is initiated by a payer, and thereafter the encrypted image signal is decrypted.

Preferably, the step S701 further includes: processing the image signal by the image sensor so that the processed image signal is provided with an image sensor identifier corresponding to the image sensor, and performing a first encryption on the image signal with a first encryption algorithm corresponding to the image sensor identifier. Correspondingly thereto, there is further included before the step S702 the steps of obtaining the image sensor identifier, judging authenticity of the image sensor identifier and performing a first decryption on the image signal with a first decryption algorithm corresponding to the obtained image sensor identifier when the image sensor identifier is authentic.

Preferably, there is further included before the step S701 the step of transmitting a public key to the image sensor so that the image sensor encrypts the image signal based upon the public key. Correspondingly thereto, the step S702 further includes: performing a second decryption on the image signal base upon a private key corresponding to the public key.

In this embodiment, the receiver may be an authentication server or the like, and it performs at least one decryption on the received encrypted image signal and judges authenticity of the image sensor identifier to determine whether a payment behavior is initiated by a payer before decrypting the received encrypted image signal to thereby further improve the security of the payment system.

FIG. 8 is a schematic diagram of an identification authentication method according to an eighth embodiment of the invention. In this embodiment, a still or moving image of a physical feature of a human body 810, for example, a human face feature or a fingerprint feature, is obtained directly through one or more image sensors on a handset, a computer or another device. Preferably the obtained image signal is processed by an image signal processing module inside the image sensor so that the processed image signal is provided with an image sensor identifier corresponding to the image sensor, and the image signal is encrypted with a first encryption algorithm corresponding to the image sensor identifier.

Then the image signal provided with the image sensor identifier and encrypted with the first encryption algorithm is transferred to an encryption module. Preferably, the encryption module is controlled by an encryption enabling signal so that when the encryption enabling signal is not valid, the encryption module will not encrypt the image signal, and when the encryption enabling signal is valid, the encryption module encrypts the image signal again. The encryption scheme may be a scheme to use at least a specific fixed encryption algorithm preset in the image sensor or to select at least a specific encryption algorithm in a software or hardware manner from several encryption algorithms. For each time of encryption, at least one of the encryption schemes may be predetermined or randomly selected in a hardware or software manner in the encryption module as desired in practice. Preferably, in the encryption scheme, the image signal is encrypted using a public key transmitted from a back-end authentication server 830 or a manual authentication server 840, that is, an operation is performed, on the information to be encrypted, using the public key in a specific encryption algorithm, and then uploaded to the back-end authentication server 830 over a communication network of the device.

The back-end authentication server 830 receives the encrypted image and then searches in a user name-image sensor identifier correspondence table pre-stored on the server for an image sensor identifier corresponding to a user name, and if the found image sensor identifier is consistent with the received image sensor identifier, then the image sensor identifier is judged to be authentic, that is, it is determined that a payment behavior is initiated by a payer, and thus the encrypted image signal is decrypted; and if the found image sensor identifier is not consistent with the received image sensor identifier, then the image sensor identifier is judged to be unauthentic, and thus the encrypted image signal will not be decrypted. When the image sensor identifier is judged to be authentic, firstly the received image information is decrypted using the private key corresponding to the public key, that is, the encryption process with the public key is cancelled off by a decryption operation with the private key to obtain the image signal with the image sensor identifier encrypted with the first encryption algorithm, which is then decrypted with a first decryption algorithm corresponding to the obtained image sensor identifier to obtain the image signal.

The manual authentication server 840 compares the image signal with the feature image originally entered by the user for recognition, and upon successful recognition, the manual authentication server 840 requests the user to take his or her self-defined photographed expressional feature to transfer to the back-end authentication server 830, and the authentication server authenticates the expressional feature. If the comparison therebetween results no error, which indicates a successful authentication and thus secured payment may proceed. If either of the steps fails in the back-en automatic authentication, then the process will proceed to the manual authentication server 840 where the photographed image is compared directly with the original feature image manually. Passage of automatic or manual authentication indicates successful payment authentication; otherwise, the authentication is considered to fail. With authentication finished, the authentication server downloads an authentication result to the device over a communication network. During the above human body physical feature taking process, it is required to display image of the physical feature of the individual in a particular screen area of an input device so as to ensure the accuracy of authentication.

In this embodiment, the payment authentication system 800 in which the payment authentication method is performed includes two ends in communication with each other, where one of the ends is a handset, a computer or another device 820 including an image sensor, which may be implemented according to the fifth or sixth embodiment, and the other end is the back-end authentication server 830 and/or the manual authentication server 840, which may be implemented according to the seventh embodiment. As can be appreciated, this system may reduce the possibility of embezzling the image signal from both of the ends to thereby improve the security of the entire payment system.

Although a detailed description of various embodiments of the invention has been set forth in the foregoing disclosure, it shall be appreciated that the legal scope of the invention will be defined by the text of the appended claims of this patent application. The detailed description shall be construed to be merely exemplary but not to exhaust every possible embodiment of the invention because a description of every possible embodiment might be impractical even if not impossible. Various alternative embodiments possible with various technologies currently known or developed later than the filing date of this patent application shall also come into the scope of the appended claims of the invention.

1. An image sensor, wherein the image sensor comprises:
a sensing module configured to optically sense an image and to convert an optical signal of the image into an image signal; and
an encryption module configured to encrypt the image signal and to output the encrypted image signal.

2-20. (canceled)
